(19) United States
(12) Patent Application Publication
(10) Pub. No.: US 2012/0319813 A1
(43) Pub. Date: Dec. 20, 2012

(54) APPARATUS AND METHOD FOR PROCESSING A SCENE

(75) Inventors: Seong Yong Lim, Daejeon (KR); In Jae Lee, Daejeon (KR); Ji Hun Cha, Daejeon (KR); Hee Kyung Lee, Daejeon (KR)

(73) Assignee: Electronics and Telecommunications Research Inst., Daejeon (KR)

(21) Appl. No.: 13/522,475

(22) PCT Filed: Jan. 14, 2011
(86) PCT No.: PCT/KR2011/000310

§ 371 Date: Jul. 16, 2012

Related U.S. Application Data
(60) Provisional application No. 61/295,276, filed on Jan. 15, 2010.
(60) Provisional application No. 61/297,341, filed on Jan. 22, 2010.

(30) Foreign Application Priority Data
Jul. 23, 2010 (KR) 10-2010-0071589

(51) Int. Cl. G06F 13/42

(52) U.S. Cl. 340/1.1

(57) ABSTRACT

Provided is an apparatus and method for processing a scene that may prevent overload of a scene caused by transmission of excessive information, by generating geometric information corresponding to meaningful information, as which sensed information may be construed semantically, and by only transmitting the geometric information to the scene, instead of transmitting, to the scene, all of the sensed information with respect to a real world.

### TECHNICAL FIELD

The present invention relates to an apparatus and method for processing a scene, and more particularly, to an apparatus and method for processing interaction of a real world and a scene.

### BACKGROUND ART

The Moving Picture Experts Group (MPEG) corresponds to standards that may be applied to compression of a moving picture, that is, a video. The name of MPEG was derived from the MPEG, an affiliated organization of International Organization for Standardization (ISO). Generally, storage and processing of voice and video information may require much more memory than text information including characters. The above-described characteristic has been a huge obstacle to development of a multimedia application program. Accordingly, there has been a considerable interest in a compression technology that may reduce a size of a file without changing contents of information of the file.

An apparatus for processing a scene with respect to an MPEG-U of the MPEG will be hereinafter described.

FIG. 1 is a diagram illustrating interaction among a real world 130, an advanced user interaction interface (AUI) apparatus 120, and a scene 110 according to an embodiment of the present invention.

Referring to FIG. 1, the AUI apparatus 120 may sense physical information with respect to the real world 130. The AUI apparatus 120 may sense the real world 130, and may collect sensed information, for example, the physical information.

The AUI apparatus 120 may configure an action corresponding to the scene 110 in the real world 130. The AUI apparatus 120 may act as an actuator to configure the action corresponding to the scene 110 in the real world 130.

The AUI apparatus 120 may include a motion sensor, a camera, and the like.

Also, the physical information collected by the AUI apparatus 120 may be transmitted to the scene 110. In this instance, the physical information with respect to the real world 130 may be applied to the scene 110.

When all of the physical information collected by the AUI apparatus 120 from the real world 130 is transmitted to the scene 110, overload of the scene 110 may be induced. That is, a great deal of the physical information may induce the overload of the scene 110.

A new method of processing the scene 110 that may prevent the overload of the scene 110 will be described hereinafter.

### DISCLOSURE OF INVENTION

### Technical Goals

The purpose of embodiments of the present invention may be to prevent overload of a scene caused by transmission of excessive information, by generating geometric information corresponding to meaningful information, as which sensed information may be construed semantically, and by only transmitting the geometric information to the scene, instead of transmitting, to the scene, all of the sensed information with respect to a real world.

### Technical Solutions

According to an aspect of the present invention, there is provided an apparatus for processing a scene that may process an interaction of a real world and the scene, including a receiver to receive, from an advanced user interaction interface (AUI) apparatus, sensed information with respect to the real world, a generator to generate geometric information associated with the scene, based on the sensed information, and a transmitter to transmit the geometric information to the scene.

The geometric information may indicate a data format representing an object associated with the scene.

According to an aspect of the present invention, there is provided an apparatus for processing a scene that may process the interaction of a real world and the scene, including a receiver to receive, from a motion sensor, sensed information with respect to a motion of a user, a generator to generate geometric information with respect to an object corresponding to the motion of the user, based on the sensed information, and a transmitter to transmit the geometric information to the scene.

The sensed information may include information with respect to at least one of a position, an orientation, a velocity, an angular velocity, an acceleration, and an angular acceleration, with respect to a feature point of the user.

When the object corresponds to a circle, the geometric information may include information with respect to the radius of the circle, and the center of the circle.

When the object corresponds to a rectangle, the geometric information may include information with respect to an upper-left vertex of the rectangle, and a lower-right vertex of the rectangle.

When the object corresponds to a line, the geometric information may include information with respect to a pair of points on the line.

According to an aspect of the present invention, there is provided a method of processing a scene that may process the interaction of a real world and the scene, including receiving, from an AUI apparatus, sensed information with respect to the real world, generating geometric information with respect to the scene, based on the sensed information, and transmitting the geometric information to the scene.

According to an aspect of the present invention, there is provided a method of processing a scene that may process the interaction of a real world and the scene, including receiving, from a motion sensor, sensed information with respect to a motion of a user, generating geometric information with respect to an object corresponding to the motion of the user, based on the sensed information, and transmitting the geometric information to the scene.

### EFFECT OF INVENTION

It is possible to prevent overload of a scene caused by transmission of excessive information, by generating geometric information corresponding to meaningful information, as which sensed information may be construed semantically, and by only transmitting the geometric information to the scene, instead of transmitting, to the scene, all of the sensed information with respect to a real world.

### BRIEF DESCRIPTION OF DRAWINGS

FIG. 1 is a diagram illustrating interaction among a real world, an advanced user interaction interface (AUI) apparatus, and a scene according to an embodiment of the present invention.

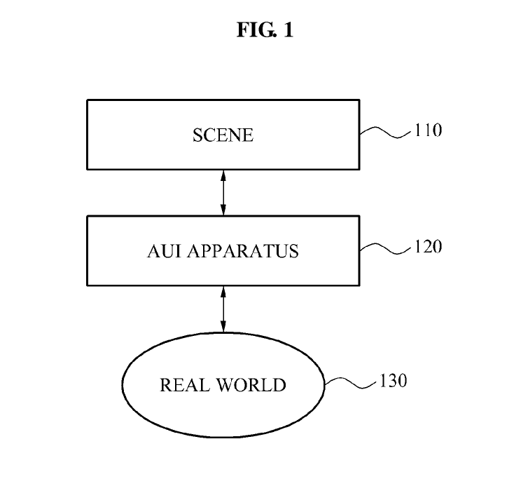

FIG. 2 is a diagram illustrating a configuration of an apparatus for processing a scene according to an embodiment of the present invention.

FIG. 3 is a diagram illustrating an operation that an apparatus for processing a scene may generate geometric information using a motion sensor according to an embodiment of the present invention.

FIG. 4 is a flowchart illustrating a method of processing a scene according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

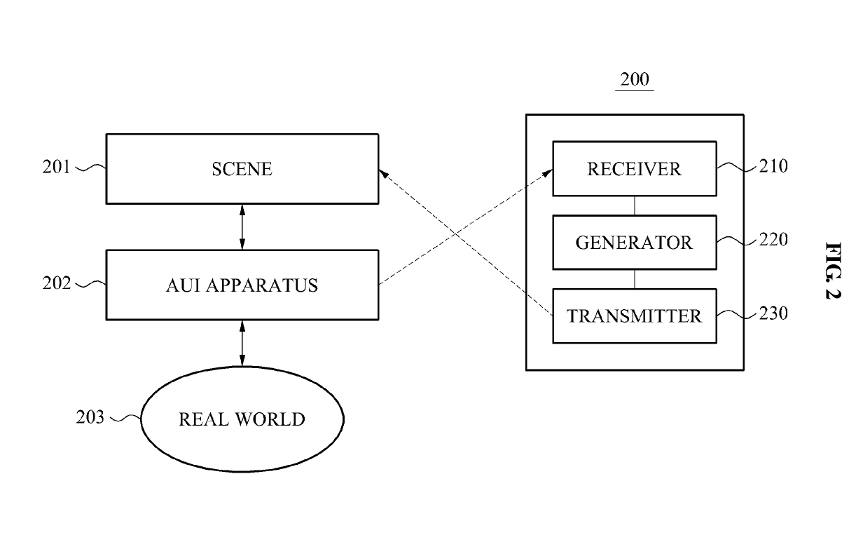

FIG. 2 is a diagram illustrating a configuration of an apparatus 200 for processing a scene according to an embodiment of the present invention.

Referring to FIG. 2, the apparatus 200 for processing the scene that may process an interaction of a real world 203 and the scene 201, may include a receiver 210, a generator 220, and a transmitter 230.

The receiver 210 may receive sensed information with respect to the real world 203, from an advanced user interaction interface (AUI) apparatus 202.

The AUI apparatus 202 may collect information with respect to the real world 203, by sensing the real world 203.

For example, when a user in the real world 203 clicks a mouse, the AUI apparatus 202 may sense information, with respect to a position of the mouse, at a point in time when a mouse click event occurs, a relative position on the scene 201, a movement velocity, and the like, and may collect the sensed information.

The AUI apparatus 202 may transmit, to the apparatus 200 for processing the scene, the sensed information with respect to the real world 203. In this instance, the receiver 210 may receive, from the AUI apparatus 202, the sensed information with respect to the real world 203.

The generator 220 may generate geometric information associated with the scene 201, based on the received sensed information.

The geometric information may indicate a data format representing an object associated with the scene 201.

The apparatus 200 for processing the scene may prevent overload of the scene 201 caused by transmission of excessive information, by generating the geometric information corresponding to meaningful information, as which the sensed information may be construed semantically, and by only transmitting the geometric information to the scene 201, instead of transmitting, to the scene 201, all of the sensed information that the AUI apparatus 202 may sense, with respect to the real world 203.

The transmitter 230 may transmit the generated geometric information to the scene 201.

Accordingly, the scene 201 may process only the geometric information by receiving the geometric information corresponding to the meaningful information, without receiving all of the sensed information with respect to the real world 203.

An operation of the apparatus 200 for processing the scene when the AUI apparatus 202, for example, a motion sensor, is used will be described hereinafter.

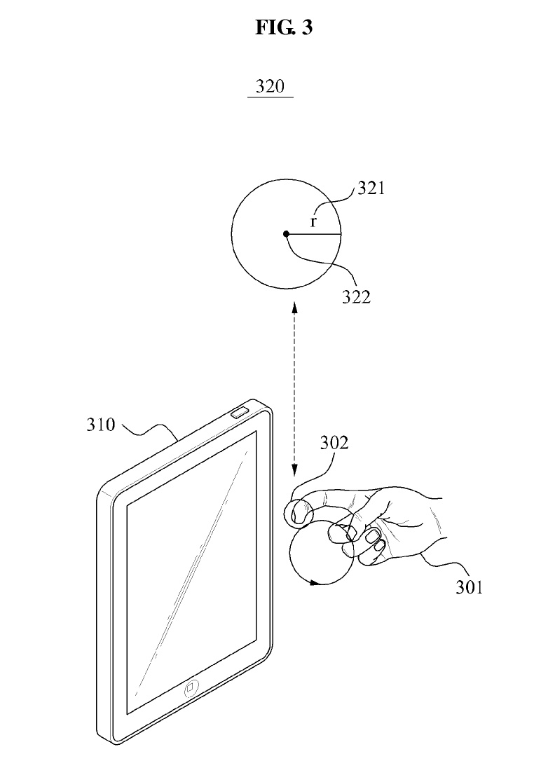

FIG. 3 is a diagram illustrating an operation, in which an apparatus for processing a scene may generate geometric information, using a motion sensor 310 according to an embodiment of the present invention.

Referring to FIG. 3, the motion sensor 310 corresponding to an AUI apparatus may sense a motion of a user 301, of the real world, and may collect sensed information with respect to the motion of the user 301.

The motion sensor 310 may sense a motion of a feature point of the user 301. The feature point may correspond to a predetermined body part of the user 301 for sensing the motion of the user 301. For example, the feature point may be set to a fingertip 302 of the user 301.

The motion sensor 310 may sense at least one of a position, an orientation, a velocity, an angular velocity, an acceleration, and an angular acceleration, with respect to the feature point of the user 301.

The motion sensor 310 may transmit, to the apparatus for processing the scene, the collected sensed information with respect to the motion of the user 301.

In this instance, a receiver of the apparatus for processing the scene may receive, from the motion sensor 310, the sensed information with respect to the motion of the user 301.

A generator may generate geometric information with respect to an object corresponding to the motion of the user 301, based on the sensed information.

For example, when the fingertip 302, of the user 301, draws a circle 320, the object corresponding to the motion of the user 301 may correspond to the circle 320, and accordingly the generator may generate the geometric information corresponding to the circle 320.

The generator may generate the geometric information including information with respect to the radius 321 of the circle 320, and the center 322 of the circle 320 when the object corresponds to the circle 320.

When the fingertip 302 of the user 301 draws a rectangle, the object corresponding to the motion of the user 301 may correspond to the rectangle, and accordingly the generator may generate the geometric information corresponding to the rectangle.

The generator may generate the geometric information including information with respect to an upper-left vertex of the rectangle, and a lower-right vertex of the rectangle when the object corresponds to the rectangle.

When the fingertip 302, of the user 301, draws a line, the object corresponding to the motion of the user 301 may correspond to the line, and accordingly the generator may generate the geometric information corresponding to the line.

The generator may generate the geometric information including information, with respect to a pair of points on the line, when the object corresponds to the line.

Also, when the fingertip 302, of the user 301, repeatedly draws circles, the object corresponding to the motion of the user 301 may correspond to a plurality of the circles, and accordingly the generator may generate the geometric information corresponding to the plurality of the circles.

The generator may generate the geometric information including a set of information with respect to the radius and the center of each of the plurality of the circles when the object corresponds to the plurality of the circles.

When the fingertip 302 of the user 301 repeatedly draws rectangles, the object corresponding to the motion of the user 301 may correspond to a plurality of the rectangles, and accordingly the generator may generate the geometric information corresponding to the plurality of the rectangles.

The generator may generate the geometric information including a set of information with respect to an upper-left vertex and a lower-right vertex of each of the plurality of the rectangles when the object corresponds to the plurality of the rectangles when the object corresponds to the plurality of the rectangles.

When the fingertip 302 of the user 301 draws a pair of lines with opposite directions, the object corresponding to the motion of the user 301 may correspond to the pair of lines with the opposite directions, and accordingly the generator may generate the geometric information corresponding to the pair of lines with the opposite directions.

The generator may generate the geometric information including a set of information with respect to a pair of points with respect to each of the pair of lines.

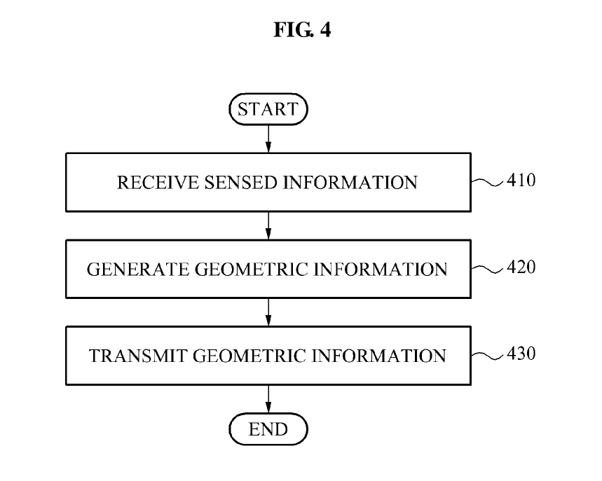

FIG. 4 is a flowchart illustrating a method of processing a scene according to an embodiment of the present invention.

Referring to FIG. 4, the method of processing the scene that may process an interaction of a real world and the scene may receive, from an AUI apparatus, sensed information with respect to the real world, in operation 410.

The AUI apparatus may collect information with respect to the real world by sensing the real world.

For example, when a user in the real world clicks a mouse, the AUI apparatus may sense information with respect to a position of the mouse at a point in time when a mouse click event occurs, a relative position on the scene, a movement velocity, and the like, and may collect the sensed information.

The AUI apparatus may transmit, to an apparatus for processing a scene, the sensed information with respect to the real world. In this instance, the apparatus for processing the scene may receive, from the AUI apparatus, the sensed information with respect to the real world.

In operation 420, the method of processing the scene may generate geometric information associated with the scene, based on the received sensed information.

The geometric information may indicate a data format representing an object associated with the scene.

The method of processing the scene may prevent overload of a scene caused by transmission of excessive information, by generating the geometric information corresponding to meaningful information, as which sensed information may be construed semantically, and by only transmitting the geometric information to the scene, instead of transmitting, to the scene, all of the sensed information with respect to a real world.

In operation 430, the method of processing the scene may transmit the generated geometric information to the scene.

Accordingly, the scene may process only the geometric information by receiving the geometric information corresponding to the meaningful information, without receiving all of the sensed information with respect to the real world.

A method of processing a scene when the AUI apparatus, for example, a motion sensor, is used will be described hereinafter.

The AUI apparatus, for example, the motion sensor may sense a motion of a user of the real world, and may collect sensed information with respect to the motion of the user.

The motion sensor may sense a motion of a feature point of the user. The motion sensor may sense at least one of a position, an orientation, a velocity, an angular velocity, an acceleration, and an angular acceleration, with respect to the feature point of the user.

In this instance, the method of processing the scene may receive, from the motion sensor, the sensed information with respect to the motion of the user. Also, the method of processing the scene may generate geometric information with respect to an object corresponding to the motion of the user, based on the sensed information.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. An apparatus for processing a scene that processes interaction of a real world and a scene, the apparatus comprising:
a receiver to receive sensed information with respect to the real world;
a generator to generate geometric information associated with the scene, based on the sensed information; and
a transmitter to transmit the geometric information to the scene.

2. The apparatus of claim 1, wherein the geometric information indicates a data format representing an object associated with the scene.

3. The apparatus of claim 1, wherein:
the receiver receives, from a motion sensor, sensed information with respect to a motion of a user, and
the generator generates geometric information with respect to an object corresponding to the motion of the user, based on the sensed information with respect to the motion of the user.

4. The apparatus of claim 3, wherein the sensed information, with respect to the motion of the user comprises information, with respect to at least one of a position, an orientation, a velocity, an angular velocity, an acceleration, and an angular acceleration, with respect to a feature point of the user.

5. The apparatus of claim 3, wherein, when the object corresponds to a circle, the geometric information with respect to the object comprises information with respect to the radius of the circle, and the center of the circle.

6. The apparatus of claim 3, wherein, when the object corresponds to a rectangle, the geometric information with respect to the object comprises information with respect to an upper-left vertex of the rectangle, and a lower-right vertex of the rectangle.

7. The apparatus of claim 3, wherein, when the object corresponds to a line, the geometric information with respect to the object comprises information with respect to a pair of points on the line.

8. A method of processing a scene that processes interaction of a real world and a scene, the method comprising:
receiving sensed information with respect to the real world;
generating geometric information associated with the scene, based on the sensed information; and
transmitting the geometric information to the scene.
